(19) United States
(12) Patent Application Publication
(10) Pub. No.: US 2012/0213248 A1
(43) Pub. Date: Aug. 23, 2012

(54) System and Method for Warm Body Presence Detection

(75) Inventors: Lior Segal, Herzeliya (IL); Yoel Motola, Herzeliya (IL)

(73) Assignee: THIRD EYE SYSTEMS LTD., Ramat-Gan (IL)

(21) Appl. No.: 13/505,292

(22) PCT Filed: Nov. 4, 2010
(86) PCT No.: PCT/IL2010/000916

§ 371 Date: May 1, 2012

(30) Foreign Application Priority Data
Nov. 4, 2009 (IL) 201915

(51) Int. Cl. G01J 5/00

(52) U.S. Cl. 374/121

(57) ABSTRACT

A system and method for warm body presence detection, the system comprising a detection unit comprising a light focusing unit for absorbing light from an inspected region; and a thermal detection unit for receiving the absorbed light, sensing infrared radiation and generating a signal indicative of the sensed infrared radiation; and a processing unit for analyzing the generated signal and deciding based on the analysis whether a warm body presence has been detected. The method for warm body presence detection comprises receiving and analyzing by a processing unit inputs from a short wavelengths thermal detector and a long wavelengths thermal detector, the inputs comprise indications of the amount of emitted infrared radiation in the respective wavelength ranges inspected by each thermal detector, and deciding that a warm body presence has been detected in case the emitted infrared radiation values detected by both thermal detectors correspond to predefined values.

### FIELD OF THE INVENTION

This invention relates generally to warm body presence detection and more particularly to portable device for real-time warm body presence detection indoors and outdoors.

### BACKGROUND OF THE INVENTION

Detecting a warm body presence in nearby surroundings, with or without a clear line of sight to the target or in an environment with faulted visibility, is a valuable commodity for many different objectives. For example, an automobile sensing a warm body in its course can automatically be stopped or warn the driver. A rescue robot going through building ruins sensing a living body can transmit its location to the rescue team helping them to reduce the period of time to save that person.

There are few conventional means for warm body detection. For example, Night Vision goggles use Infra-Red (IR) or Forward Looking Infrared (FLIR) technology (Thermal or Star-Light vision), which are both very expensive and have different kind of problems. For example, IR goggles have problems in urban areas for the lack of star-light. Additionally, these methods require image processing and recognition tools.

Flashlights can be used in order to see clearly in a dark environment compelling the user to have a clear line of sight to the target and exposing the user to forces nearby.

Many households use thermal detection devices in a stationary form in order to detect intruders. The currently available devices use several methods for detecting a warm body entering the device's field of view (FOV), all of these devices assume that the only moving part in the surroundings is the intruder. Hence, those devices have problems handling portability of the sensing device itself. Furthermore, alarm systems are triggered when no one is at home and all electrical appliances are turned off, hence, differentiating between a human body and a kitchen oven is unhandled, ultimately, causing many false alarms.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram illustrating a system for warm body presence detection according to embodiments of the present invention;

FIG. 2 is a schematic more-detailed illustration of an exemplary detection unit according to some embodiments of the present invention;

FIG. 3 is a schematic graph illustrating the amount of emitted infrared radiation as a function of wavelength for different temperatures and exemplary wavelength ranges of thermal detectors according to embodiments of the present invention;

FIG. 4 is a flowchart illustrating a method for warm body presence detection according to some embodiments of the present invention;

FIG. 5 is a flowchart illustrating a method which may facilitate detection of a warm body without being dependent on and/or misled by the environment temperature, according to embodiments of the present invention;

FIG. 6 is a schematic illustration of an exemplary mounting option of a system for warm body presence detection according to embodiments of the present invention;

FIG. 7 is a schematic illustration of another exemplary mounting option of device for warm body presence detection according to embodiments of the present invention; and

FIG. 8 is a schematic illustration of another exemplary mounting option of device for warm body presence detection according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The system and method according to embodiments of the present invention may provide a portable device to detect warm body presence in indoors and/or outdoors environments, which may be light-weight, low-cost and highly reliable. The device may enable warm body presence detection, for example, where visibility is faulted (because of smoke, fog, darkness, corners etc.) and/or without line of sight to the target. This device, unlike other devices currently in the market, may operate while in movement and doesn't need to stay stationary. For example the device may allow the user or the carrier of the device to be in movement while operating the device.

A warm body presence detection device according to embodiments of the present invention may be autonomic, an element of a detection system or mounted on a carrier, for example as a tracking device and/or triggering device. The device may be mounted, for example, on rescue equipment (such as robots etc.), vehicles (for example, as proximity sensor), weapons, soldiers (for example, on the helmet, weapon or other equipment), animals such as service or assistance dogs (such as rescue dogs, assault dogs, detection dogs etc.), any kind of standard ammunition (for example, as a guiding system) or on any other suitable carrier. According to some embodiments of the present invention, the detection device according to embodiments of the present invention may be mounted on most carriers without modifying the carrier itself, using a simple connector. According to some exemplary embodiments of the present invention, the detection device may include a relatively light weight, single piece mounting base which is separate from the body of the sensor and which can be mounted to a weapon, helmet or other equipment. Therefore, embodiments of the present invention may overcome deficiencies of some of the known detection tools by providing a device which can be quickly and easily mounted and oriented to cover and/or scan a specific area without requiring a special installation tool.

As an autonomic device, the warm body presence detection device according to embodiments of the present invention may be utilized as a detection system, which may operate statically or movably. For example, the autonomic detection device may be thrown or fired into a room or other space and may notify a user if a human or other warm body is present in this room or in the other space.

The system and method according to embodiments of the present invention may provide undetectable, silent and safe scanning of large areas for the presence human or other warm body in a short period of time from activation/installation/placement.

According to some embodiments of the present invention, the warm body presence detection device may utilize thermal sensors, which may enable passive sensing of human and/or animal presence without exposing the user by means of light or otherwise visible indications. Furthermore, thermal sensors do not emit any kind of radiation (such as Microwaves, Sonic waves, RF waves etc.) to the environment. Therefore, a detection device which utilizes thermal sensors according to embodiments of the present invention cannot be detected by hostile radiation sensing devices, and cannot be affected by interrupting radiation transmissions. Additionally, thermal sensors are relatively low cost sensors.

The warm body presence detection device according to embodiments of the present invention may inflict substantially no damage to the environment, may have high resistance in rough conditions and may be reusable.

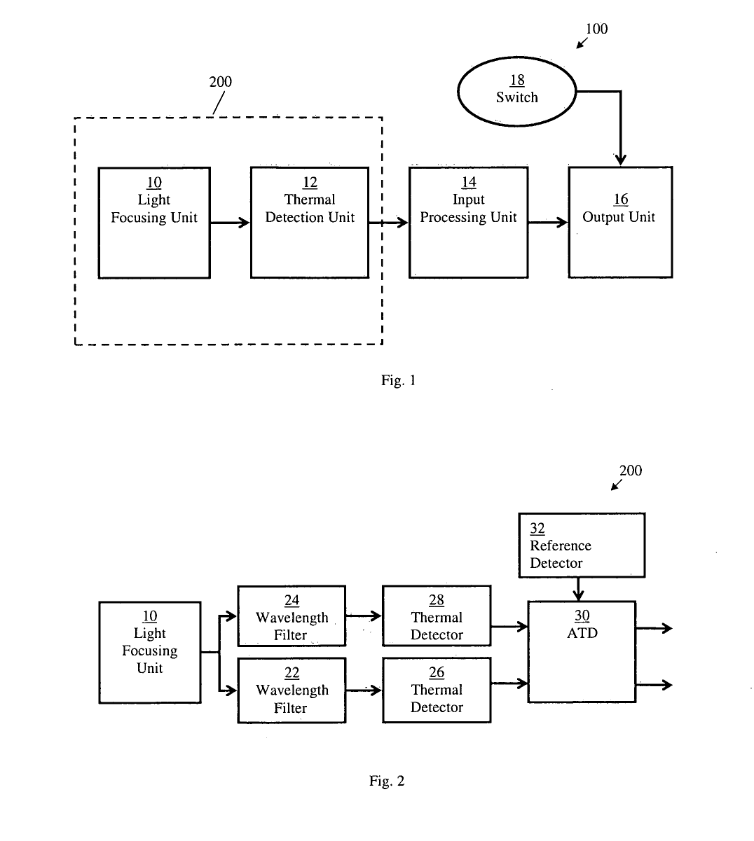

Reference is now made to FIG. 1, which is a schematic block diagram illustrating a system 100 for warm body presence detection according to embodiments of the present invention. A system according to embodiments of the present invention may include a detection unit 200, an input processing unit 14, an output unit 16 and a switch unit 18. Detection unit 200 may include a light focusing unit 10 and a thermal detection unit 12.

Light focusing unit 10 may include, for example, lenses, mirrors and/or any other suitable optical element, for focusing light gathered from a certain inspected region into thermal detection unit 12. In some embodiments, Light focusing unit 10 may include a Fresnel lens or other lens designed to minimize optical aberrations by using, for example, aspheric surfaces, a-periodic groove structures and/or constant depth grooves.

Thermal detection unit 12 may receive the light from the inspected region through light focusing unit 10. Thermal detection unit 12 may translate the received light into electrical signal. As described in more detail herein below with reference to FIG. 2, thermal detection unit 12 may include, for example, thermal detectors, wavelength filters, amplifiers and/or electronics which may be used for translating the received light into electrical signal. Thermal detection unit 12 may include, for example, passive sensor elements which may react to energy sources in an inspected region, for example by sensing difference between the heat emitted from the energy sources and the environment in the inspected region. The resulted electrical signal may be transmitted from detection unit 200 to input processing unit 14.

Input processing unit 14 may include at least one data processing element such as, for example, a digital signal processor, a microcontroller and/or any other suitable element.

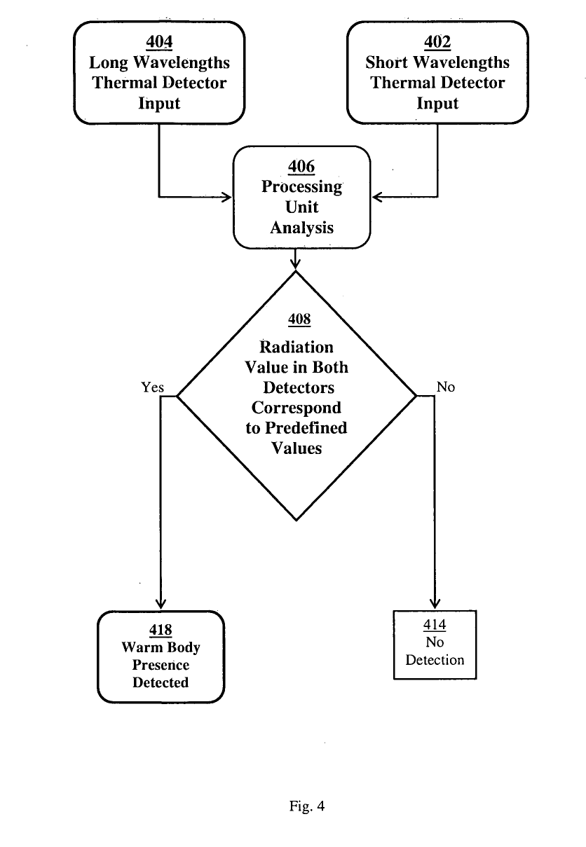

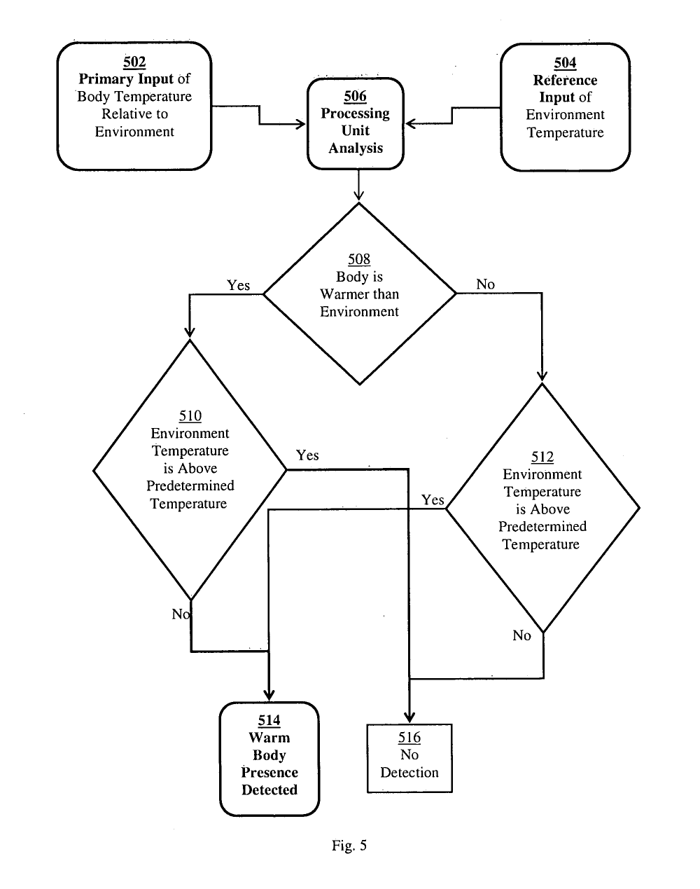

Input processing unit 14 may process and/or analyze the electrical signal received from detection unit 200, for example in order to reduce to minimum the number of false alarms. The analysis may be performed by input processing unit 14 according to methods provided by embodiments of the present invention, for example as described herein below with reference to FIGS. 4 and 5. The methods provided by embodiments of the present invention are designed specifically for system 100 and may consider movement, temperature, detected object size etc. Based on the analysis, input processing unit 14 may decide whether or not a warm body presence has been detected, and therefore, for example, whether or not to trigger an alert output indicating that a warm body presence has been detected.

In some embodiments, system 100 may be able to identify whether the warm body is a friend or a foe, for example based on unique spectral differentiation equipment that may be worn by friendly forces. For example, a cold chemical substance (in a certain pattern) worn on top of a person uniform, may facilitate identification of a warm body as a friendly person.

Based on the decision whether or not a warm body presence has been detected and/or whether the warm body is a friend or a foe, input processing unit 14 may provide instructions to output unit 16. In case the decision of input processing unit 14 is that an alert output should be triggered, output unit 16 may indicate to the user that a warm body presence has been detected, for example by means of visual output, computer data transfer, audio output and/or any other suitable indicating means. Additionally, input processing unit 14 may provide instructions to output unit 16 to indicate to a user whether the warm body detected is either a friend or a foe.

Switch unit 18 may enable selection of the alert output indicating means, selection of the working mode of the device, software updates and/or other possible changes in the device performance.

In some embodiments of the present invention, system 100 may further include a remote control (not shown), wired or wireless, which may control, for example, switch 18. Further, in some embodiments of the present invention, system 100 may further include a wired or wireless output port (not shown) for data transfer to a work station such as, for example, a computer or a mobile device. Further in some embodiments of the present invention, some or all of the system elements may be encased in a case (not shown). The case may be, for example, rigid and/or waterproof case. The case may be, for example, in shape and size similar to a weapon-mountable flashlight.

Reference is now made to FIG. 2, which is a schematic more-detailed illustration of an exemplary detection unit 200 according to some embodiments of the present invention. Detection unit 200 may include light focusing unit 10 described above with reference to FIG. 1. Additionally, detection unit 200 may include wavelength filters 22 and 24, thermal detectors 26 and 28, an analog-to-digital (ATD) converter 30 and a reference detector 32. Wavelength filters 22 and 24, thermal detectors 26 and 28, and ATD converter 30 may be included in thermal detection unit 12 described above with reference to FIG. 1. Thermal detectors 26 and 28 may measure infrared light radiating from objects. Thermal detectors 26 and 28 may include, for example, thermopile sensors, micro-Bolometers, Pyroelectric sensors and/or any other suitable thermal sensor component(s).

Each of thermal detectors 26 and 28 may include a thermal sensor element or an array of thermal sensor elements (not shown). Each of the elements may include a transducer (not shown) for generating signal strength according to the intensity of an incident light beam and thus, for example, enable detection of temperatures and/or changes in temperatures in the inspected region. Detection unit 200 may further include an output circuit (not shown) or several output circuits for outputting the signals generated by thermal detector 26 and/or 28 at a frame rate depending, for example, on movement speed of thermal detector 26 and/or 28 and/or on the signal strength. The output circuits may generate output signals, for example, based on the signal strength generated by the transducer in each thermal sensor element. Additionally, detection unit 200 may further include an output-controlling unit (not shown) for controlling the operation of the output circuit(s). The generated output signals may be received by input processing unit 14 described above, which may include a plurality of signal-processing circuits (not shown). For output signal of each element, input processing unit 14 may select a predetermined one of the signal-processing circuits, for example based on the respective position of the element in the element array.

Wavelength filters 22 and 24 may include, for example, narrow and/or wide optical band pass filters (BPF). Wavelength filters 22 and 24 may enable transmission of specific spectrums of wavelengths to thermal detectors 26 and 28, for example, to distinguish between heat emitted from warm body such as, for example, human body, and heat emitted from other objects. In some embodiments of the present invention, wavelength filters 22 and/or 24 may include an array of wavelength filter elements (not shown), located correspondingly to the thermal sensor elements discussed above. The wavelength range of each filter element may correspond to the position of the respective sensor element in the elements array, thus, for example, allowing the thermal sensor to operate only in the desired wavelength range. This may enable distinguishing between two different warm bodies with different wavelength ranges.

At normal body temperature, a human body may radiate at wavelengths around 10 μm. Therefore, a filter which may pass wavelengths in a range for example of 7-14 μm may be used. Each of wavelength filters 22 and 24 may pass light in a different range or different ranges of wavelengths than the other wavelength filter. For example, one of wavelength filters 22 and 24 may pass light in a wavelength range of 3-5 μm, 4-12 μm, 2-20 μm and/or other, while the other wavelength filter may pass light in a wavelength range of 8-12 μm, 12-20 μm and/or other. In some embodiments, for example in order to assist in reducing false alarms, it is possible that each of wavelength filters 22 and 24 may pass two or more bands of wavelength. For example, one of wavelength filters 22 and 24 may pass light in wavelength ranges of 3-5 μm and 4-12 μm, while the other wavelength filter may pass light in wavelength ranges of 8-12 μm and 12-20 μm.

Each of thermal detectors 26 and 28 may receive light from one of wavelength filters 22 and 24, respectively, and generate an electrical signal based on the received light signal, for example by output circuits as discussed above. In some embodiments of the present invention, for example, different wavelength spectrums of the received light signal may cause different output signals from thermal detector 26 and/or 28.

The electrical signal generated by thermal detectors 26 and 28 may be transmitted to ATD converter 30, which may convert the signals received from thermal detectors 26 and 28 to digital signals. The resulted digital signal may be transmitted for further processing from detection unit 200 to input processing unit 14, described above with reference to FIG. 1. In other embodiments of the present invention, ATD converter 30 may be included in input processing unit 14. Digital signal processing may be preferred over analog signal processing, for example because errors and/or noise can be more easily detected and/or corrected.

It will be appreciated that in some embodiment of the present invention, detection unit 200 may include more than two thermal detectors 26 and 28 and a respective number of wavelength filters, for example, in order to facilitate detection and/or reduce false alarms. In some embodiments of the present invention, each thermal detector may scan another portion of the inspected region.

In some embodiments of the present invention thermal detector 26 and/or 28 may be calibrated to ignore certain interferences coming from the environment, such as, for example, changes in the environment temperature. Additionally, thermal detector 26 and/or 28 may change the reference temperature, for example, in order to recognize a human body in a cold or hot environment. The reference temperature, for example, the temperature of the environment, may be detected by reference detector 32, which may generate a temperature signal indicative of the environment's temperature. Reference detector 32 may communicate the temperature signal to ATD converter 30, which may convert the temperature signal to a digital signal. The resulted signal may be transmitted to input processing unit 14 for further processing, for example for calibration of the signals received from thermal detector 26 and/or 28.

In further embodiments of the present invention, additional means may be utilized for reducing distortions. For example, a reticle/chopper element (not shown) can be used for background discrimination. The pattern and movement of the reticle, in combination with the optical system, may enhance the quality of the received object and suppress the background negative effect. A reticle/chopper element may also be used in order to split incoming light radiation between two sensors.

As described above with reference to FIG. 1, input processing unit 14 may analyze the electrical signal received from detection unit 200 and may decide based on the analysis whether or not to trigger an alert output indicating that a warm body presence has been detected. The usage of thermal detectors 26 and 28 and the respective wavelength filters 22 and 24, together with the analysis by input processing unit 14, may reduce false detections of warm body by system 100. Such false detections may occur, for example, when infrared radiation emitted from something other than an inspected target. Such occurrences may be caused by environmental factors such as localized thermal imbalances and/or gentle air disturbances, which may produce localized shift of infrared energy that may be imperceptible or nearly imperceptible for natural humans, yet may be detected by thermal detector 26 and/or 28.

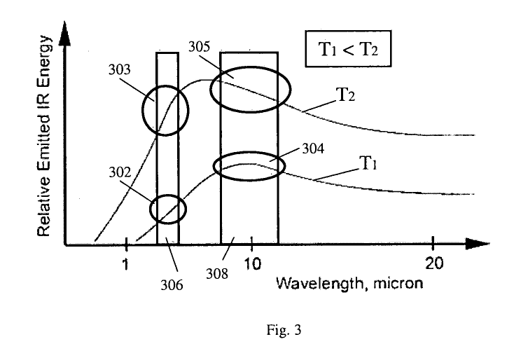

Reference is now made to FIG. 3, which is a schematic graph illustrating the amount of emitted infrared radiation as a function of wavelength for different temperatures and exemplary wavelength ranges of thermal detectors according to embodiments of the present invention. The curves notated T1 and T2 illustrate the amount of emitted infrared radiation as a function of wavelength for temperatures T1 and T2, respectively, wherein, for example, T2 is a higher temperature than T1. T1 and T2 may be, for example, the temperatures of two different radiating bodies. Rectangles 306 and 308 may represent the wavelength ranges inspected by, for example, thermal detectors 26 and 28, respectively, by using, for example, filters 22 and 24. For example, as shown by rectangle 306, thermal detector 26 may inspect a wavelength range of about 3-5 μm, and, as shown by rectangle 308, thermal detector 28 may inspect a wavelength range of about 8-14 μm. In other embodiments, thermal detectors 26 and/or 28 may inspect other wavelength ranges. For example, thermal detector 26 may inspect a wavelength range of about 4-12 μm and/or thermal detector 28 may inspect a wavelength range of about 12-20 μm. For each detected radiating body, two different output signals may be generated by the thermal detectors 26 and 28, respectively, representing the radiation values for each inspected wavelength range. For each radiating body with temperature T1 or T2, each of thermal detectors 26 and/or 28 may detect a typical radiation value in the respective wavelength range. For example, for a radiating body with temperature T1, thermal detector 26 may detect radiation in typical values indicated by the circled region 302 and thermal detector 28 may detect radiation in typical values indicated by the circled region 304. For a radiating body with temperature T2, thermal detector 26 may detect radiation in typical values indicated by the circled region 303 and thermal detector 28 may detect radiation in typical values indicated by the circled region 305. Since in some embodiments, thermal detectors 26 and 28 may detect only relative values, certain mathematical manipulations may be performed, for example, by processing unit 14, in order to verify that the values detected by thermal detectors 26 and 28 correspond to the required typical values.

Reference is now made to FIG. 4, which is a flowchart illustrating a method for warm body presence detection according to some embodiments of the present invention. The method for warm body presence detection according to embodiments of the present invention may reduce false detections of warm body presence in the inspected region. As indicated in blocks 402 and 404, input processing unit 14 may receive inputs from short wavelengths thermal detector such as, for example, detector 26 and long wavelengths thermal detector such as, for example, detector 28. The inputs from thermal detectors 26 and 28 may include, for example, indication of the amount of emitted infrared radiation in the respective wavelength ranges. As indicated in block 406, the inputs may be analyzed by input processing unit 14, for example, to deduce whether the emitted infrared radiation values correspond to predefined typical values which correspond to a predetermined warm body temperature, for example of a warm body system 100 is designated to find.

As indicated in block 408, the processing by input processing unit 14 may include deducing whether the emitted infrared radiation values detected by both detectors correspond to predefined values, for example to typical values which correspond to temperature of a certain warm body. As indicated in block 414, in case the emitted infrared radiation value detected by at least one of detectors 26 and 28 does not correspond to the predefined value, input processing unit 14 may decide that no relevant warm body presence has been detected. As indicated in block 418, in case the emitted infrared radiation values detected by both detectors correspond to the predefined values, input processing unit 14 may decide that a warm body presence has been detected.

In order to decide whether the emitted infrared radiation values detected by both detectors correspond to the predefined values, input processing unit 14 may perform various mathematical manipulations on the signals generated by detectors 26 and 28. For example, input processing unit 14 may compare the values detected by detector 26 to the values detected by detector 28, in order to deduce if the values detected by detector 26 relate to the values detected by detector 28 in a manner which correspond the typical values. For example, input processing unit 14 may divide a value detected by detector 26 by a corresponding value detected by detector 28 or vice versa. For example, input processing unit 14 may divide a value detected by detector 26 by a value detected by detector 28 on the same time or on a proximate time, or vice versa. Input processing unit 14 may store a data base of predefined values and/or thresholds to which the result of the mathematical manipulation may be compared. Input processing unit 14 may decide whether the values detected by detectors 26 and 28 indicate detection of a relevant warm body, for example based on comparison of the result of a mathematical manipulation performed on the values detected by detectors 26 and 28 to predefined values and/or thresholds stored in the database.

Based on the decision, input processing unit 14 may provide instructions to output unit 16, as described above with reference to FIG. 1. In case the decision of input processing unit 14 is that a warm body presence has been detected, input processing unit 14 may trigger an alert output by output unit 16. Output unit 16 may indicate to the user that a warm body presence has been detected, for example by means of visual output, computer data transfer, audio output and/or any other suitable indicating means.

Some known thermal detectors work under assumption that a human body is warmer than the environment, and therefore indicate only a positive change in temperature a change to a warmer temperature than the environment). Reference is now made to FIG. 5, which is a flowchart illustrating a method for warm body presence detection according to some embodiments of the present invention. The method illustrated in FIG. 5 may facilitate detection of a warm body such as, for example, a human body or an animal body, without being dependent on and/or misled by the environment temperature, according to embodiments of the present invention.

As indicated in blocks 502, input processing unit 14 may receive primary input which may include and/or be indicative of, for example, temperature of a detected body relative to the environment temperature in the inspected region and/or indication on whether the detected body temperature is higher or lower than the environment temperature. The primary input may be generated by and/or received from thermal detectors 26 and 28 and/or may be extracted from the signals received from thermal detectors 26 and 28. As indicated in blocks 504, input processing unit 14 may receive reference input which may include and/or may be indicative of, for example, the temperature of the environment in the inspected region and/or indication on whether the environment temperature is higher than a predetermined temperature, for example a typical temperature of a certain kind of warm body, such as about 28-32° C. for the surface of a human body. In some embodiments of the present invention, for example in case thermal detectors 26 and/or 28 are able to detect absolute temperatures, the reference input may be generated by and/or received from thermal detectors 26 and 28 and/or may be extracted from the signals received from thermal detectors 26 and 28. In some other embodiments, the reference input may be generated by and/or received from reference detector 32 described above with reference to FIG. 2. As indicated in block 506, the inputs from the primary and reference detectors may be analyzed by input processing unit 14.

The processing by input processing unit 14 may include deducing whether the detected body temperature is higher or lower than the environment temperature (block 508). In case the detected body is warmer than the environment, input processing unit 14 may make a decision based on whether the environment temperature is higher than a predetermined temperature (block 510). In case the environment temperature is higher than the predetermined temperature, input processing unit 14 may decide that no relevant warm body presence has been detected (block 516). In case the environment temperature is lower than the predetermined temperature, input processing unit 14 may decide that a relevant warm body presence has been detected (block 514).

In case the detected body is colder than the environment, input processing unit 14 may make a decision based on whether the environment temperature is higher than the predetermined temperature (block 512). In case the environment temperature is higher than the predetermined temperature, input processing unit 14 may decide that a relevant warm body presence has been detected (block 514). In case the environment temperature is lower than the predetermined temperature, input processing unit 14 may decide that no relevant warm body presence has been detected (block 516).

Based on the decision, input processing unit 14 may provide instructions to output unit 16, as described above with reference to FIG. 1. In case the decision of input processing unit 14 is that a warm body presence has been detected, input processing unit 14 may trigger an alert output by output unit 16. Output unit 16 may indicate to the user that a warm body presence has been detected, for example by means of visual output, computer data transfer, audio output and/or any other suitable indicating means.

As mentioned above, the device according to embodiments of the present invention may be mounted on other devices, vehicles, humans and/or service animals by a mounting device, for example without requiring alteration of the carrier device. The mounting device may be a generic mounting device which may fit various carriers.

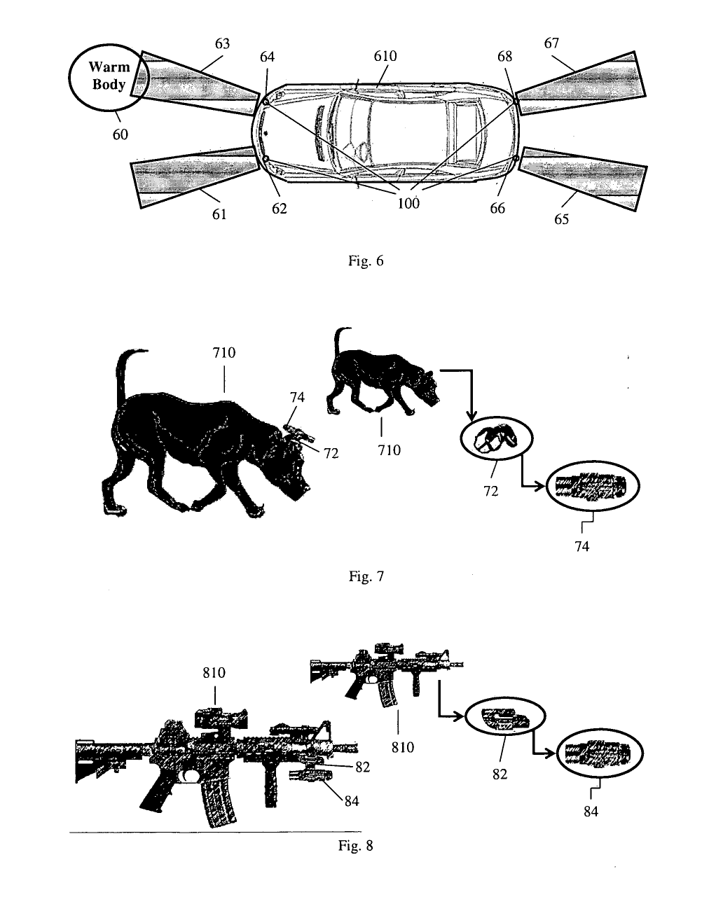

Reference is now made to FIG. 6, which is a schematic illustration of an exemplary mounting option of a system 100 for warm body presence detection according to embodiments of the present invention. For example, system 100 according to embodiments of the present invention can be mounted on vehicle 610, for example at locations 62, 64, 66 and/or 68, covering the respective regions 61, 63, 65 and 67. When a warm body 60 enters one of the detection regions, the driver may receive an alert from system 100 that vehicle 610 should be stopped/slowed down. In other embodiments, vehicle 610 may automatically stop/slow down upon receiving suitable instructions from system 100.

Reference is now made to FIG. 7, which is a schematic illustration of another exemplary mounting option of device 74 for warm body presence detection according to embodiments of the present invention, which may be similar and/or operate similarly to system 100 described above, and/or include all or some of the elements of system 100. For example, device 74 according to embodiments of the present invention can be mounted on a service animal or equipment 710 (such as a dog, a robot or another utility service equipment), for example by a mounting element 72, for example on the forehead. Mounting element 72 may include, for example, a head harness. In some embodiments, mounting element 72 may be especially designed for mounting device 74 on service animal or equipment 710. Mounted on service animal or equipment 710, device 74 may detect warm body presence while service animal or equipment 710 is working on a mission, such as, for example, a rescue mission, detection mission, searching for explosive substance, searching for hostile presence and/or any other mission. When a warm body enters the detection area of device 74, an alert may be sent from device 74 to a user's device and/or work station. In some embodiments, the device may provide instructions to service animal or equipment 710, for example to rescue, to attack and/or to confine the detected body. In some embodiments, the device may provide to service animal or equipment 710 indication of whether the warm body is a friendly person or a foe and/or instructions accordingly.

Reference is now made to FIG. 8, which is a schematic illustration of another exemplary mounting option of device 84 for warm body presence detection according to embodiments of the present invention, which may be similar and/or operate similarly to system 100 described above, and/or include all or some of the elements of system 100. For example, device 84 according to embodiments of the present invention can be mounted on a firearm 810, for example by a mounting device 82. Mounting device 82 may enable mounting of device 84 without modification of firearm 810, and may additionally be suitable for mounting device 84 on other kinds of equipment and/or vehicles. Mounted on service firearm 810 or another equipment, device 84 may detect warm body presence while a person holding firearm 810 or another equipment device 84 is mounted on is working on a mission, such as, for example, a rescue mission, a military mission and/or any other mission. When a warm body enters the detection area of device 84, an alert may be sent from device 84 to a user's device and/or work station. In some embodiments, the device may provide instructions to a person holding firearm 810 or another equipment device 84 is mounted on, for example to rescue, to attack and/or to confine the detected body. In some embodiments, the device may provide to a person holding firearm 810 or another equipment device 84 is mounted on indication of whether the warm body is a friendly person or a foe and/or instructions accordingly.

Another exemplary mounting option according to embodiments of the present invention, may be mounting of system 100 or device including system 100 on rocket propelled or ballistic ammunition, for example in order to operate as a guiding system and/or tracking device, for example for tracking hostile persons and/or vehicles. In some embodiments, system 100 or device including system 100 may be used as a triggering system, for example for standard or custom made explosive-charges and land mines.

Another exemplary mounting option according to embodiments of the present invention, may be mounting of system 100 or device including system 100 on a tank and/or a military armored vehicle, for example in order to inform soldiers inside the vehicle about suspicious bodies in the vehicle's proximity before opening a hatch or turret.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-16. (canceled)

17. A system for warm body presence detection, the system comprising:
a detection unit comprising:
a light focusing unit operative to absorb light from an inspected region; and
a thermal detection unit operative to receive at least two specific spectrums of wavelengths of the absorbed light, to sense infrared radiation from the spectrums of wavelengths, and to generate signals indicative of the sensed infrared radiation; and
a processing unit operative to decide based on the generated signals whether a warm body is present in the inspected region;
wherein the system detects warm body presence regardless of whether the system is stationary or moving with respect to the inspected region during operation.

18. The system according to claim 17, wherein said thermal detection unit comprises:
an array of thermal sensor elements operative to generate signal strengths according to the intensity of an incident infrared light beam; and
an output circuit operative to generate output signals based on the strengths of the signals generated by the thermal sensor elements.

19. The system according to claim 17, wherein the thermal detection unit includes at least two thermal detectors and at least two wavelength filters, each thermal detector receiving a specific spectrum of wavelengths from one of the at least two wavelength filters.

20. The system according to claim 19, wherein each of the at least two thermal detectors includes an array of thermal sensor elements operative to generate signal strengths according to the intensity of an incident infrared light beam.

21. The system according to claim 17, wherein at least one of the detection unit and/or the processing unit are mounted on a mobile carrier.

22. The system according to claim 17 further comprising:
a reference detector operative to sense the environment temperature;
wherein the processing unit is further operative to receive the sensed environment temperature and to decide based on the environment temperature and the signals generated by the thermal detection unit whether a warm body is present in the inspected region.

23. A system for indicating the warm body presence detection, the system comprising:
a detection unit comprising:
a light focusing unit operative to absorb light from an inspected region;
a thermal detection unit operative to generate first and second radiation signals indicative of infrared radiation sensed within first and second spectrums of wavelengths, respectively; and
a reference detector operative to generate a reference signal indicative of an environment temperature; and
a processing unit operative to:
determine a first body temperature based on the first radiation signal and the reference signal;
determine a second body temperature based on the second radiation signal and the reference signal;
decide that an alert output should not be triggered, if both the first body temperature and the second body temperature do not correspond to a predetermined temperature;
determine a radiation-dependent value based on the first and second radiation signals, if at least one of the first and second body temperatures do correspond to the predetermined temperature; and
trigger an alert output, if the radiation-dependent value is determined and corresponds to predefined values.

24. The system according to claim 23, wherein the thermal detection unit comprises:
an array of thermal sensor elements operative to generate signal strengths according to the intensity of an incident infrared light beam.

25. A system according to claim 23, wherein the thermal detection unit includes at least two thermal detectors and at least two wavelength filters, each thermal detector receiving a specific spectrum of wavelengths from one of the at least two wavelength filters.

26. The system according to claim 25, wherein each of the at least two thermal detectors includes an array of thermal sensor elements operative to generate signal strengths according to the intensity of an incident infrared light beam.

27. The system according to claim 23, wherein at least some of the detection unit and/or the processing unit are mounted on a mobile carrier.

28. A method for warm body presence detection, the method comprising:
receiving a reference signal indicative of an environment temperature;
receiving a first radiation signal indicative of infrared radiation sensed within a first spectrum of wavelengths;
determining a first body temperature based on the first radiation signal and the reference signal;
receiving a second radiation signal indicative of infrared radiation sensed within a second spectrum of wavelengths;
determining a second body temperature based on the second radiation signal and the reference signal;
deciding that an alert output should not be triggered, if both the first body temperature and the second body temperature do not correspond to a predetermined temperature;
determining a radiation-dependent value based on the first and second radiation signals, if at least one of the first and second body temperatures do correspond to the predetermined temperature; and
triggering an alert output, if the radiation-dependent value is determined and corresponds to predefined values.

29. The method according to claim 28, wherein the first and second radiation signals are generated by an array of thermal sensor elements that generate signal strengths according to the intensity of an incident infrared light beam.

30. The method according to claim 28, wherein the first and second radiation signals are generated by at least two thermal detectors each receiving a specific spectrum of wavelengths from a separate wavelength filter.

31. The method according to claim 30, wherein each of the at least two thermal detectors includes an array of thermal sensor elements operative to generate signal strengths according to the intensity of an incident infrared light beam.

32. The method according to claim 28, wherein at least one of the receiving, the determining, the deciding, and the triggering are performed on a mobile carrier.

33. The method according to claim 28 further comprising:
indicating whether a detected body is a friend or a foe.
